(19) United States
(12) Patent Application Publication
(10) Pub. No.: US 2006/0132837 A1
(43) Pub. Date: Jun. 22, 2006

(54) Platform independent remote printing system

(76) Inventors: Michael Barth, Heidelberg (DE); Michael Szardenings, Gruibingen (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/019,140

(22) Filed: Dec. 20, 2004

(51) Int. Cl. G06F 3/12

(52) U.S. Cl. 358/1.15

(57) ABSTRACT

A print request is received at a reusable software component of a server and forwarded to a server application. The server application provides in response to the print request print data to the server's reusable software component, which, in turn, sends a second print request and forwards the print data from an interface of the server's reusable software component to the client. The client receives the second print request and print data at an interface of a reusable software component of the client; and forwards the print data to a spool system of the client in response to the second print request.

### BACKGROUND

1. Field of the Invention

The invention relates to a printing architecture and method. In particular, the invention relates to system independent architecture and method to print to a remote printer.

2. Description of the Related Art

FIG. 1 is a block diagram of a prior art remote printing architecture and method 100. A server computing system (“host”) 105 includes the hardware and software components to support a spool server 110 with remote printing capability. Such hardware and software includes one or more processors, memory for data and code storage, input/output interfaces, communication buses, operating system software, spool database, and other typical hardware and software components known to those of ordinary skill in the art.

A client computing system (“target host”) 125 is connected via a communication medium 120, for example, a Local Area Network (LAN) or Wide Area Network (WAN) to host 105. Target host 125 may be a desktop personal computer (PC) running the Microsoft Windows™ or UNIX operating system. The target host includes a user interface, for example, a graphical user interface (GUI) 130, that one uses to access and execute transactions on host 105, for example, to cause host to access a database and generate a report. Target host further includes line printer daemon (LPD) or print server 140, either as part of the operating system or as separate system software, which provides for the process of transferring output data, e.g., the report, from the spool server on host 105 to a spool system 150 on target host. GUI and LPD/printer server 140 are platform dependent, that is, the modules typically use a proprietary method for transferring data between the modules. Spool system 150 provides spooled output to an output device, e.g., a printer 160, via a communication link. The link may support parallel, asynchronous (e.g., RS-232), Universal Serial Bus (USB), or some other communication protocol.

Spool server 110 comprises an application server and multiple spool work processes to which spool requests are dispatched. Spool server 110 receives a print request from a user of target host 125 and generates a spool request. The spool request specifies a print document to be printed (“spool data”). Spool server 110 forwards spool data specified in the print request to a spool database (not shown) for temporary storage. As part of the spool request, spool work process 115 receives a request to output the spool data from spool server 110 and formats the data into a data stream that output device 160 understands, if a specific device definition for 160 is configured, otherwise, spool work process 115 formats the data into a data stream for a generic device, and leaves formatting specific to output device 160 to daemon 140. Spool work process 115 issues a remote function call (RFC) to forward the formatted spool data to the target host's line printer daemon or a print server (e.g., Microsoft Windows NT/2000 TCP/IP print server). The daemon/printer server 140 accepts the data stream, formats as necessary for output device 1660, and forwards it to the target host's spool system 150, which, in turn, sends the data to printer 160 when the printer is ready.

The architecture and method described above requires assessing the print architecture and configuring the host and/or the target host in order to address the output device 160. Configuring the host includes creating a generic or specific device definition in host 105 for the output device to which to print a document, and specifying a type of connection or an access method with which the output device is connected to host 105. Furthermore, a proprietary method (e.g., RFC) must be set up for transferring the spooled data to the target host. Unfortunately, configuring, and the tight coupling of communication between, the spool work process 115, GUI 130 and LPD/print server 140 make it difficult to migrate the print architecture to other host and/or target host systems. This creates further problems for mobile users - their local printer may change as they move to different locations, and a configuration for the printer may not exist.

### SUMMARY

A client application and corresponding server application establish a connection between each other via communication medium. The server application may receive a request to print data from client application. Server application generates the print data in response and forwards the print data to a print component of the server. The print component operates as a proxy for peer print component on the client and transmits the print data across the connection to the client's print component, along with a print request. The client's print component handles printing the print data using the client's spool and print systems.

### BRIEF DESCRIPTION OF THE DRAWINGS

The appended claims set forth the features of the invention with particularity. The embodiments of the invention, together with its advantages, may be best understood from the following detailed description taken in conjunction with the accompanying drawings in which:

FIG. 1 is a block diagram of a prior art remote printing architecture and method.

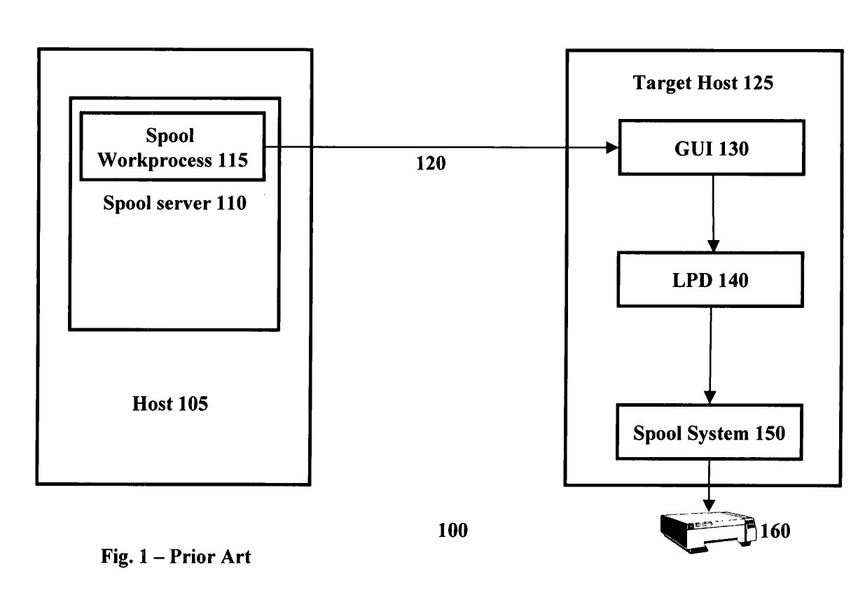

FIG. 2 is a block diagram of an embodiment of the invention.

### DETAILED DESCRIPTION

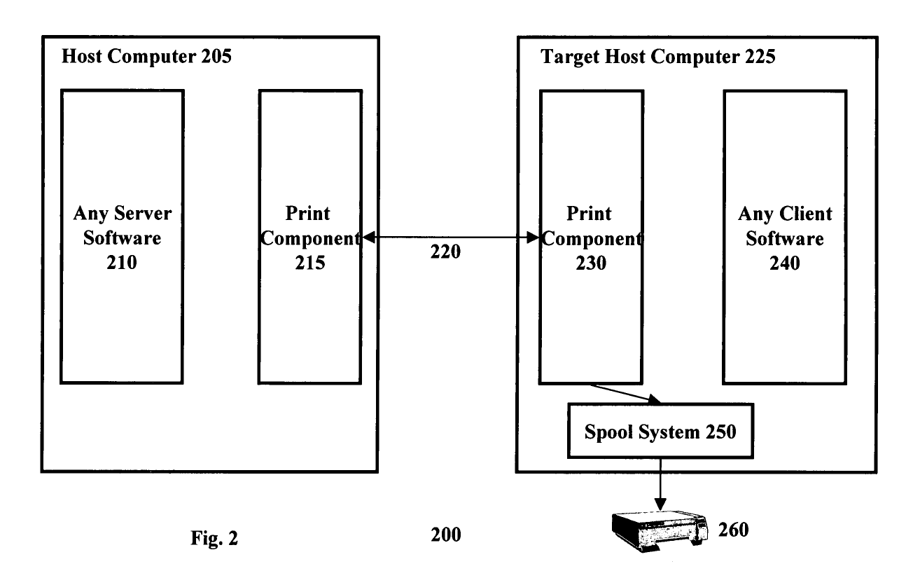

With reference to FIG. 2, a platform-independent remote printing system 200 is described. A host computer system 205 may operate as a server, and execute software applications 210 to perform transactions requested by or to benefit one or more client applications 240 executing on computer systems such as client computing system 225. For example, host 205 may support the WebSphere Application Server Java 2 Enterprise Edition (J2EE) and Web Services-based application server software platform available from International Business Machines. Alternatively, host 205 may implement a Web services application server utilizing the .NET framework of software technologies available from Microsoft Corporation.

One or more client systems 225 (“target hosts”) are coupled to host 205 via a communication medium 220, for example, a LAN, WAN, intranet or the Internet. A target host may be coupled to an output device such as printer 260. A user of a target host 225 may access information on host 205, generate a report or otherwise generate output based on that information, and direct the output to be printed. Advantageously, according to the invention, one need not provide configuration information regarding printer 260 to host 205 in order for the user to output information from host 205 to printer 260.

In one embodiment of the invention, target host system 225 includes a reusable software component, for example, a component developed using java Beans, available from Sun Microsystems, OLE (Object Linking and Embedding), or COM (Component Object Model), both available from Microsoft Corporation. The reusable software component (the “print component 230”) comprises a printer interface and a print method. The print component 230 exists autonomously and independently from any other components of either host 205 or target host 210. Any client software application, for example, a client application 240, can implement print component 230. The print component 230 can be called multiple times with requests to print output to target host 225's local printer 260. Likewise, in one embodiment of the invention, host system 205 includes a reusable software component (“print component 215”), which comprises a printer interface and a print method. Any server software application, for example, a server application 210, can implement print component 215.

A client application 240 and corresponding server application 210 establish a connection between each other via communication medium 220 and transmit information between the applications using the connection. For example, a server application 210 executing on host 205 may receive a request to print data from client application 240 executing on target host 225. Server application 210 receives the print request and generates the print data in response thereto. Server application 210 forwards the print data to a method of print component 215. Print component 215 operates as a proxy for peer print component 230 on target host 225 and transmits the print data across the connection to print component 230, along with a print request (proxy's print request).

In one embodiment of the invention, print component 215 encodes the print data into a platform-independent stream of data, for example, a bit stream, and uses its interface to transmit the data stream to the interface of print component 230. Print component 230's interface receives the proxy's print request, and the data stream. The data stream is decoded to obtain the original print data. In response to the proxy's print request, print component 230's print method then forwards the print data to the target host's spool system 250, where the print data is formatted if needed, and then transmitted to printer 260 when the printer is ready. Printer 260 then prints the print data.

In one embodiment of the invention, print component 215 transmits, and print component 230 receives, print data in a well-defined format, for example, either a commonly used page description language (PDL) such as Adobe® PostScript® 3™, available from Adobe Systems Corporation, or Printer Control Language (PCL), available from Hewlett-Packard Corporation. Alternatively, print component 215 transmits the print data in accordance with a document description that is interpreted by the receiving print component 230. For example, the print data may be transmitted in a Standard Generalized Markup Lanuage (SGML) or eXtensible Markup Language (XML) formatted document.

Once print component 230 receives the print data, it forwards the same to the native printing system for target host 225. For example, the component may forward the print data to the default printer supported by target host's operating system. If the print data is formatted using a page description language, the print data may be forwarded directly to the default printer in its present form for printing. Alternatively, the print data is interpreted and converted by a method of print component 230 into a format understood by output device 260.

Numerous specific details are set forth in this description in order to provide a thorough understanding of the embodiments of the invention. It is apparent, however, to one skilled in the art that the invention may be practiced without some of these specific details. In other instances, well-known structures and devices have been shown in block diagram form to avoid obscuring the underlying principles of the invention.

Various embodiments of the invention may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link.

What is claimed is:

1. A method comprising:
receiving a print request at a reusable software component of a server;
forwarding the print request to a server application;
providing in response to the print request print data to the server's reusable software component;
sending a second print request and forwarding the print data from an interface of the server's reusable software component to the client;
receiving the second print request and print data at an interface of a reusable software component of the client; and
forwarding the print data from the client's reusable software component to a spool system of the client in response to the second print request.

2. The method of claim 1, wherein:
receiving a print request at a reusable software component of a server comprises receiving the print request at the interface of the reusable software component.

3. The method of claim 2, further comprising:
encoding the print data at the server's reusable software component prior to forwarding the print data from the server's reusable software component to the client; and
decoding the encoded print data at the client's reusable software component once received.

4. The method of claim 3, wherein encoding comprises encoding the print data into a platform-independent stream of data.

5. The method of claim 4, further comprising transmitting the print data from the spool system to an attached printer to print the print data.

6. The method of claim 1, wherein the method of the server's reusable software component forwards the print request and print data to the client's reusable software component via an established connection over a communication medium that couples the server and client.

7. The method of claim 1, wherein the print data is formatted according to a page description language.

8. The method of claim 7, wherein the page description language is Adobe PostScript 3.

9. The method of claim 7, wherein the page description language is Printer Control Language (PCL).

10. The method of claim 1, wherein the print data is formatted according to a document description language.

11. The method of claim 10, wherein the document description language is Standard Generalized Markup Language (SGML).

12. The method of claim 10, wherein the document description language is extensible Markup Language (XML).

13. A system, comprising:
a server including a server application and a reusable software component, the server's reusable software component having an interface to receive a print request and forward the same to the server application, the server application to receive the print request and provide print data in response thereto, the interface to transmit a second print request and the print data; and
a client including a spool system and a reusable software component, the client's reusable software component having an interface to receive the second print request and print data;
and a method to forward the print data to the spool system in response to the second print request.

14. The system of claim 13, further comprising a communication medium that couples the server and the client.

15. The system of claim 14, wherein the server's reusable software component to encode the print data into a platform independent data stream.

16. The system of claim 15, wherein the server's reusable software component interface transmits print data as encoded.

17. The system of claim 15, wherein the server's reusable software component to encode the data according to a page description language.

18. An article of manufacture, comprising:
a machine-readable medium that provides instructions which, when executed by a machine, cause the machine to:
receive a print request at an interface of a reusable software component of a server;
forward the print request to a server application;
provide in response to the print request print data to the server's reusable software component;
send a second print request and forwarding the print data from an interface of the server's reusable software component to the client;
receive the second print request and print data at an interface of a reusable software component of the client; and
forward the print data from the client's reusable software component to a spool system of the client in response to the second print request.

19. The article of manufacture of claim 18, wherein the machine-readable medium further provides instructions which, when executed by a machine, cause the machine to:
encode the print data at the server's reusable software component prior to forwarding the print data from the server's reusable software component to the client; and
decode the encoded print data at the client's reusable software component once received.

20. The article of manufacture of claim 19, wherein the machine-readable medium instructions which, when executed by a machine, cause the machine to encode the print data further comprises instructions that cause the machine to encode the print data according to a page description language.
